(19) United States
(12) Patent Application Publication
(10) Pub. No.: US 2004/0024808 A1
(43) Pub. Date: Feb. 5, 2004

(54) Wide area storage localization system

(75) Inventors: Yuichi Taguchi, Sunnyvale, CA (US); Akira Yamamoto, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/211,428

(22) Filed: Aug. 1, 2002

(51) Int. Cl. G06F 15/16

(52) U.S. Cl. 709/203

(57) ABSTRACT

A system is described for facilitating retrieval of information from various sites to a secondary site using mirroring or other data replication software. At the secondary site using a proxy system, an operator may retrieve data from the secondary systems mirrored to the site. The system is particularly applicable to combining disparate types of remotely situated databases.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

This invention relates to data storage systems, and in particular to systems which allow retrieval of database information.

Hardware and software vendors, working in conjunction with corporations and other entities around the world, have developed technology for intranet systems which allow a company to share its information among its employees, even though those employees are located in different offices. In such systems individual branches maintain servers which dispense information to the employees at that office. To obtain information from other offices, the client terminal searches other servers to obtain the desired information. Such a client-server architecture model requires the client to access remote servers each time the search process occurs. This means that every transaction necessitates a network delay time to receive a reply from the remote site. The network latency caused by distance and the lack of bandwidth often found between the remote sites makes it difficult to implement an intranet system on a worldwide basis.

Another approach which allows sharing of data and knowledge in a different manner is XML technology. XML theoretically makes it possible to integrate various repositories of data, even if each different repository is managed by a different organization or a different domain. While this has superficial appeal, integration of the data at this level lacks flexibility because all repositories that are integrated must be formatted with the same data structures in a static Document Type Definition (“DTD”). Operators at each site who construct the repository data must follow the DTD, precluding them from enhancing their data structures for a particular need at that site, and thereby limiting their flexibility. Similar approach has been to employ data level database integration. This, however, has also proved difficult for the same reason. The databases to be integrated must have common table spaces that are consistently defined with respect to each other.

In yet another approach, known as the Oracle Transparent Gateway (“OTG”), the databases at the different locations that are integrated are integrated virtually. The databases do not actually integrate data from each site, but client requests to the databases are split and forwarded on the multiple database servers in the proper message format. This allows the client to access the multiple servers as if they were accessing a single database. Each database, however, remains remote, subject to the difficulties of delay, etc., described above. Prior art describing each of these approaches include: (1) “Enterprise Information Integration,” published by MetaMatrix, Inc. (2001); (2) “Hitachi Data Systems 9900 and 7700E—Guideline for Oracle Database for Backup and Recovery,” published by Hitachi, Ltd. (January 2001); (3) “Guidelines for Using Snapshot Storage Systems for Oracle Databases,” by Nabil Osorio, et al., published by Oracle (August 2000); and (4) “Microsoft SQL Server on Windows NT Administrator's Guide,” published by Oracle (April 2000).

Accordingly, a need exists for the sharing of data from remote sites without need of conforming data structures and without the delays inherent in repeated querying over long distances.

### BRIEF SUMMARY OF THE INVENTION

This invention provides a storage-oriented database localization system. The system assumes a circumstance in which there are multiple remote sites, and each site has its own local database. According to a preferred embodiment, the system localizes all, or a part of, the data from each remote site into a central site. Unlike the prior solutions described above, this system does not integrate the databases at the data level, but rather, it replicates the stored data itself from the remote sites to the central site, so that copies of the database from each remote site are present at the central site. Providing the features in this manner solves the problem of flexibility of data integration and eliminates the delays of the systems described in the references above.

At the central site a database proxy server provides a gateway to each of the multiple replicas. Data access requests issued by operator at the central site are split at this proxy, made into multiple replicas and sent out to the copies of the remote databases. (The copies are also at the central site.) Replies from each replica are then merged at the proxy server before being returned to the operator. This feature provides flexibility and speed in accessing multiple stored databases.

The invention relies upon the replication mechanism now often available in storage systems. Storage equipment now typically includes a function which provides the capability of mirroring data between remote sites, without need of server CPU control. The use of the mirroring function enables mirroring data over long distances on a worldwide scale. The storage equipment associated with such mirroring operations makes it possible to guarantee the write order in the communication between a primary and a secondary site, and to even continuously provide disk mirroring over long distances.

Another feature of the invention is a snapshot controller. The snapshot controller controls a write process at the site which is to receive mirrored data from another site. The snapshot controller monitors the cache data as it arrives and checks to assure proper write order. It then allows the cached data to be written into disk space when the write order has been verified. Thus, this mechanism enables continuous data transfer without impacting the information retrieval system, thereby minimizing delays. The transfer of data between the two sites can be synchronous or asynchronous, or a combination thereof.

In a preferred embodiment of the invention, a system for facilitating retrieval of information in which a first system stores first data to first location and the second system stores second data to a second location includes several aspects. These aspects include a terminal connected to retrieve data from the first system, and a replication software program for copying data from the second system to the first system. A proxy system operating at the first location enables a user of the terminal to retrieve data from the second system which data have been copied to the first system from the second system.

### BRIEF DESCRIPTION OF THE DRAWINGS

FIG. 1 is a diagram illustrating an overall wide area storage localization system;

FIG. 2 is a block diagram of a storage system hardware structure;

FIG. 3 is a more detailed example of storage system architecture;

FIG. 4 is an example of status information for disk mirroring at a primary site;

FIG. 5 is an example of status information for disk mirroring at a secondary site;

FIG. 6 illustrates the transfer of data from a primary to a secondary system;

FIG. 7 is a flowchart for initializing a disk pair;

FIG. 8 is a flowchart of data input at a primary storage system;

FIG. 9 is a flowchart of a mirroring data transfer;

FIG. 10 is a flowchart illustrating a procedure for writing data into local disk space at a secondary site;

FIG. 11 is a diagram of a database proxy hardware structure;

FIG. 12 is a more detailed example of a database proxy architecture;

FIG. 13 is a flowchart illustrating the database proxy operation;

FIG. 14 is an example of tracking database access information;

FIG. 15 is a flowchart illustrating the search of multiple databases by a database proxy server; and

FIG. 16 is an example of how multiple data retrievals are merged at a database proxy server.

### DETAILED DESCRIPTION OF THE INVENTION

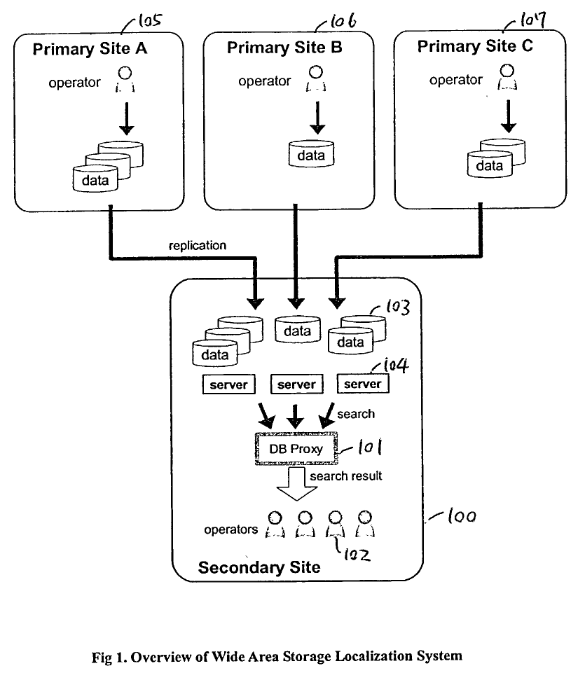

FIG. 1 is a block diagram providing an overview of a wide area storage localization system. Illustrated in FIG. 1 are three primary sites A105, B106 and C107, and one secondary site 100. Typically, sites A, B and C will be remotely located from each other and from secondary site 100. At each of the primary sites, data is managed locally by an operator. In accordance with the invention, the data stored at each primary site is replicated to the secondary site 100. Typically, this data replication operation occurs over a network, and will be performed separately for each of sites A105, B106 and C107.

The secondary site 100, collects all or a portion of the data from the primary sites and stores it, as indicated by stored data representation 103. A database proxy 101 provides access to the data 103. Data access requests from operators 102 are split by the proxy 101 and forwarded onto local database servers 104, each of which manages local replicas 103. The DB proxy 101 merges replies from the multiple servers before it returns a reply to the operator. This enables the operator to access data from the multiple databases using a single request.

The data replication process between the primary sites and the secondary site is preferably performed using conventional data replication technology, commonly known as volume mirroring. The mirroring is ideal to continuously maintain an instant replica at the secondary site; however, “ftp” data transfer executed once per week will also help operators at the secondary site. This is well known and described in some of the prior art cited herein. See, e.g., “Hitachi Data Systems 9900 and 7700E—Guideline for Oracle Database for Backup and Recovery,” published by Hitachi, Ltd. (January 2001). The database proxy server 104 are well known, for example as described in “Microsoft SQL Server on Windows NT Administrator's Guide,” published by Oracle (April 2000).

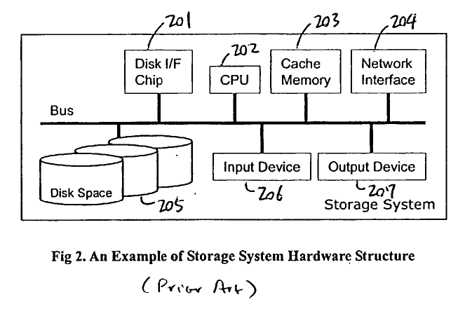

FIG. 2 is a block diagram illustrating the hardware structure of a storage system. The storage system depicted in FIG. 2 can be employed for storage of data in each of the primary and secondary sites shown in FIG. 1, or other well known systems may be used. As shown in FIG. 2 the storage system hardware structure includes storage space 205, for example, comprising an array of hard disk drives or other well known media. The storage media is connected to a bus which also includes a CPU 202, a cache memory 203, and a network interface 204 to interface the system to the bus and the network. The system also includes input and output devices 206 and 207. Disk I/F chip (or system) 201 controls input and output operations from the storage space 205. Although the configuration for the storage system depicted in FIG. 2 is relatively minimal, storage systems such as depicted there can be large and elaborate.

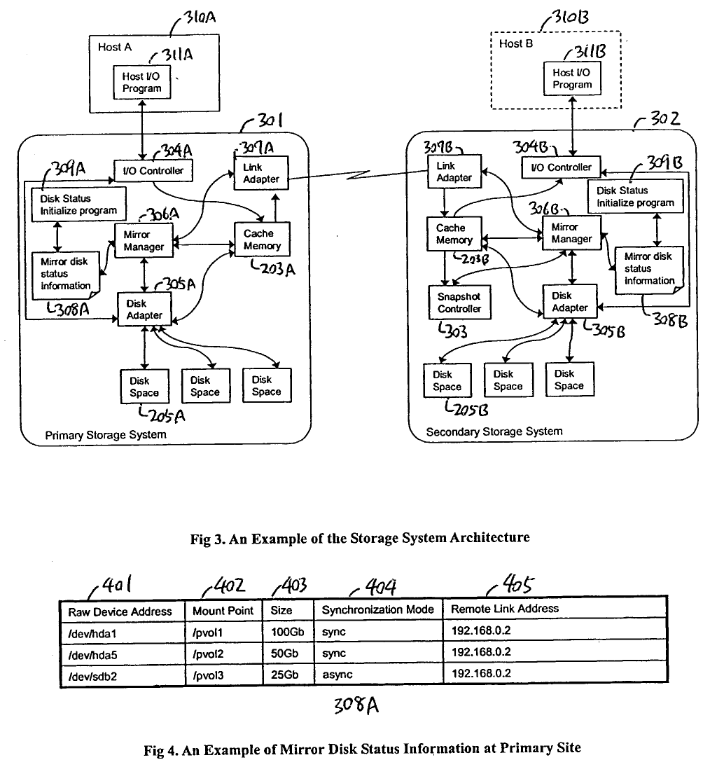

FIG. 3 is a diagram illustrating in more detail the storage system architecture. On the left portion of FIG. 3 is illustrated a primary storage system, for example such as the site A storage system 105 in FIG. 1. On the right side of FIG. 3 is illustrated a secondary storage system, such as depicted as system 100 in FIG. 1. The two systems include almost identical components, with the exception that in the illustrated embodiment secondary storage system 302 includes a snapshot controller 303 discussed below. The storage systems each include disk space 205, access to which is controlled by disk adapter 305. The disk adapter operates under control of an I/O controller 304 and a mirror manager 306. It accepts data from cache memory 203. A disk status initialization program 309 and status information 308 are also coupled to the mirror manager 306. The mirror manager 306, operating through a link adapter 307, communicates with the link adapter in other storage systems, such as depicted in FIG. 3, to exchange data. The programs involved in control and operation of the storage system are loaded into memory space 203 during operation. The disk spaces 205 are organized as disk volumes.

The host 310 operates the storage system through the I/O controller 304. The I/O controller program 310 issues a read request to the disk adapter 305 when it receives a read request from the host I/O program 311. If a write request is issued by the host program 311, then controller 304 causes the data for that write to be stored in cache memory 203, then issues the write request to the disk adapter 305.

The disk adapter 305 and its software manage data loaded from the disk volumes 205 or to the stored into the disk volumes 205. If the disk adapter 305 retrieves data from disk space 205 in response to a read request, it also stores that in cache memory 203. When disk mirroring is configured at each site, the disk adapter 305 asks for, and awaits permission, to be acknowledged by the mirror manager program 306 before beginning writing of disk volumes 205.

The mirror manager program 306A manages data replication between the primary and secondary sites. The software in the mirror manager 306A at the primary site 301 sends data that is to be written into local disk space 205A to the secondary storage system 302 through the link adapter 307A. The transferred data are then received by the link adapter 307B at the secondary site 302 and are stored into the cache memory 203A. The mirror manager program 306B at the secondary storage system 302 receives the cached data and issues an instruction to the snapshot controller program 303 to check the consistency of the data. Assuming that it is consistent, the mirror manager program 306B at the secondary site 302 instructs the write process to the disk adapter 305B.

The link adapter programs 307A and 307B manage communication between the primary and second storage systems. Preferably, the software includes a network interface device driver and typical well known protocol programs. The link adapter program 307 loads data from the cache memory 203A on the primary site, and stores it into the cache memory 203B at the secondary site when it receives it. The status of the mirroring operation is stored in status information 308, which it initialized by program 309.

FIG. 4 is a diagram which provides an example of the status of the disk mirroring operation at the primary site, while FIG. 5 is an example illustrating the status of disk mirroring at the secondary site. For this example, assume that all replications are based on disk volumes as the unit of storage space employed. The tables in FIGS. 4 and 5 list the disk volume information on each row. The table 308A in FIG. 4 illustrates the information for the primary system. For each volume the table defines the raw device address 401, the mount point 402, the volume size 403, the synchronization mode 404, and a remote link address 405. Device address, mount point and size specify volume identification information as assigned by the operating system. These are typically defined in the “/etc/fstab” file in Unix-based systems. The synchronization mode is defined as to synchronous or asynchronous based upon the replication mode. The remote link address mode 405 defines the target address assigned at the secondary site.

FIG. 5 in table 308B illustrates the same parameters for mirrored disk status information for the secondary site. It, however, also includes the remote mount point 506. The remote mount point defines the pair volume between the primary and secondary sites.

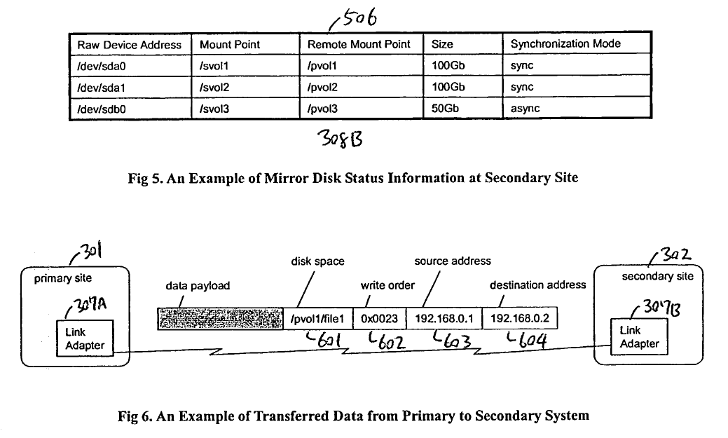

FIG. 6 is a diagram illustrating an example of transferring data from the primary storage system 301 to the secondary storage system 302. The exact mechanism depends upon the details of storage system functionality described above; however, FIG. 6 illustrates a minimum specification. In FIG. 6 an asynchronous data transfer is provided as an example, with source 603 and destination address 604 defined as IP addresses. These addresses will depend upon the communication method, so other addresses may be used, for example, worldwide name in the case of fiber channel communications. The disk space information 601 shown in FIG. 6 identifies the target file name. The write order information 602 defines the sequence of data writing. This write order field is used because the transferred data will almost always be split into multiple parts during transfer. In circumstances involving long distance communication, later parts can pass earlier parts in the network. As shown in FIG. 6, the data payload has appended to it data fields representing the disk space 601, the write order 602, the source address 603 and the destination address 604. As described in conjunction FIG. 3, the data is transferred between the link adapters of the primary and second storage systems.

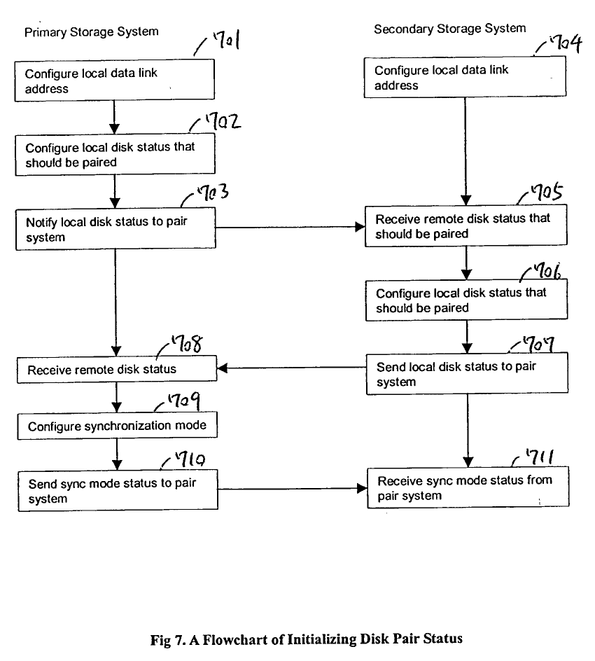

FIG. 7 is a flowchart illustrating initialization of a disk pair. This operation is carried out by the mirror manager 306 (see FIG. 3). In operation, the mirror manager 306 on both the primary system 301 and the secondary system 302 exchange information through the link adapter 307 to complete the initialization. First, at steps 701 and 704, these systems 301 and 302 configure each local data link address. For example, the system managers will assign a unique IP address for each network interface device. After that, at step 702 the primary site sets up the disk space configuration that should be mirrored or paired. Next, at step 703 the primary system 301 notifies the local mirrored disk status to the secondary system which receives the information at step 705. When the secondary system receives the information sent from the primary system at step 705, the secondary system configures the local disk space (step 706). Next, at step 707 the secondary storage system sends the local disk status information to the primary system, where it is received at step 708. When the primary system receives the information 708, it configures the synchronization mode for each disk space 709 as described in FIG. 6. Then, at step 710, it sends the synchronization mode configuration information to the secondary system where it is received at step 711. The secondary system updates the local mirrored disk status information at that time. Using these steps, both the primary and the second storage systems establish consistent mirrored disk status information at each location.

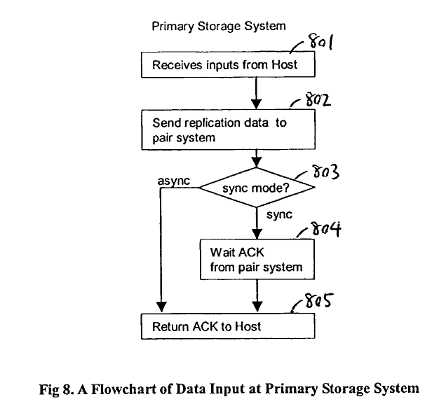

FIG. 8 is a flowchart illustrating operation of the primary storage system when it receives instructions from the host. The relationship of the host and the primary storage system are shown in FIG. 3. As shown in FIG. 8, following the initialization process described in FIG. 7, the primary storage system, at step 801, begins receiving input information from the host 310. When the storage system receives input information, it is supplied to the I/O controller 304A which stores it into the cache memory 203A (see FIG. 3). The disk adapter 305A is then notified. It awaits permission to be issued from mirror manager 306A before it processes the disk write into the local disk volumes 205A. The mirror manager 306A then forwards the replication data to the secondary system 302. This is shown by step 802 in FIG. 8.

Next, as shown by step 803, a determination is made of the synchronization mode. This determination is based upon the mirrored disk status information 308A (see FIG. 3). If the synchronization mode is set to “asynchronous,” control proceeds to step 805. On the other hand, if it is set to “synchrous,” as shown by step 804 in FIG. 8, the system will wait for an acknowledgment message 804 from the secondary system notifying the primary system that the replication has been completed successfully. In either mode, as shown by step 805, ultimately an acknowledgment signal is returned to the host to inform the host that the data was received successfully.

The actual writing of information onto the storage volumes in the primary system is performed using well known technology, for example as described in the reference “Hitachi Data Systems 9900 and 7700E—Guideline for Oracle Database for Backup and Recovery,” published by Hitachi, Ltd. (January 2001). This includes carrying out the writing of cache data into the proper disk space with the proper timing according to well known write processes.

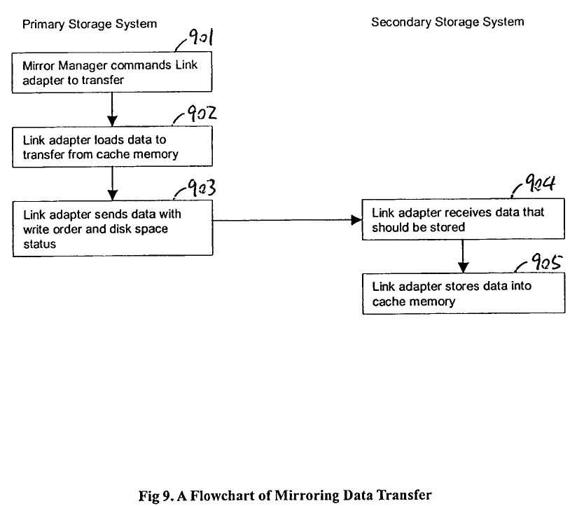

FIG. 9 is a flowchart illustrating a data transfer from the primary to the secondary system as embodied in step 802 of FIG. 8. As shown in FIG. 9, the first step 901 is for the mirror manager 306A (see FIG. 3) to command the link adapter 307A to send the data. The mirror manager 306A then notifies the target address 604 and the disk space 601 configured in the mirrored disk status information 308A. The link adapter 307A then loads the data from the cache memory 302A, as shown at step 902. It also sends the data to the target address in the format described in conjunction with FIG. 6. This operation is shown in step 903 in FIG. 9. As shown at step 904 in FIG. 9, the link adapter at 307B receives the data transferred from the primary link adapter 307A. Then, as shown in step 905, it stores that information into the cache memory.

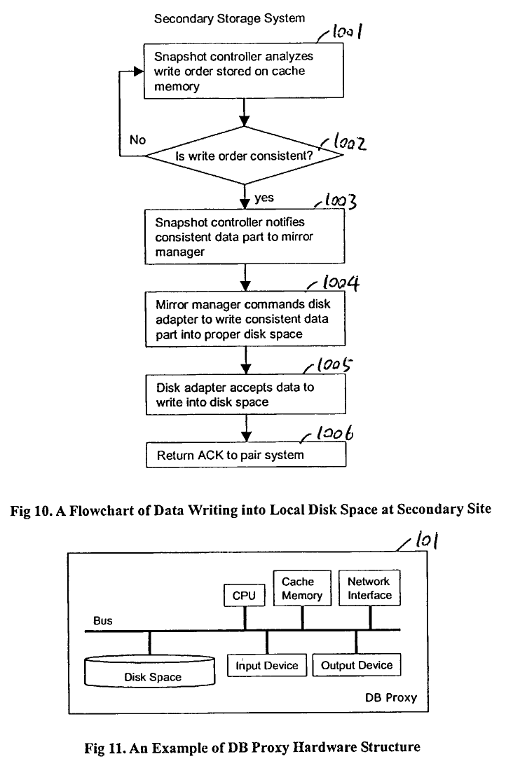

FIG. 10 is a flowchart illustrating the data writing process in which data is written into the local disk space at the secondary site. The process begins at step 1001 with the snapshot controller 303 scanning the data stored the cache memory 302B. The snapshot controller 303 monitors the write order to assure consistency. As shown by step 1002, if the write order is consistent, i.e., the data to be written is to be written next in order following the data previously written, the snapshot controller notifies the mirror manager 306B of this. This is shown at step 1003 in FIG. 10. As shown by step 1004, in response, the mirror manager 306B issues a command to the disk adapter 305B so that the disk adapter 305B processes the data write into the proper disk spaces. This operation is shown in step 1005. In response, as shown in step 1006, the mirror manager returns an acknowledgment message indicating that the data replication has been successful.

As described above, one benefit of the invention is its ability to provide an operator with access to multiple databases which have been replicated at a particular site. The DB proxy hardware server for providing this access is shown in block form in FIG. 11. As shown in FIG. 11, the hardware includes a disk, input and output devices, a CPU, a cache memory, and a network interface. In some implementations of the invention, the DB proxy hardware consists of a general purpose personal computer.

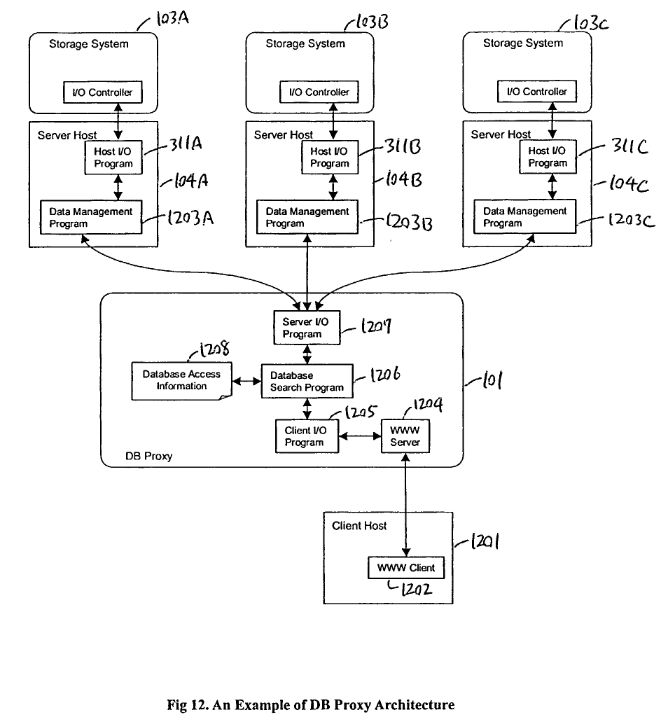

FIG. 12 is a diagram illustrating the DB proxy architecture. FIG. 12 is a more detailed version of the diagram 100 shown as a part of FIG. 1. Three storage systems 103A, 103B and 103C are shown in FIG. 12. Each includes an I/O controller coupled to a server 104A, 104B and 104C, respectively. The storage systems shown in FIG. 12 are the replicas mirrored from remote storage systems 106 (see FIG. 1). The server hosts 104 are the hosts that accept the I/O commands. The client host 1201 is the host that provides an interface for the operators 102 at secondary site 100. The database proxy 101 provides data search functions across the multiple server hosts 104A, 104B, and 104C. As shown in FIG. 12, each server host 104 includes a host I/O program 311 and a data management program 1203. The host I/O program 311 is the same as that described in FIG. 3. The data management program 1203 is a program that accepts search requests from external hosts and processes data searches in response to those requests.

The client host 1201 includes a www client 1202 which is implemented by a general web browser issuing http requests and receiving HTML contents in http messages. In FIG. 12 the client is shown as issuing requests in http; however, many other types of clients may be employed in conjunction with the invention. For example, a typical SQL client can issue data search requests in SQL messages to the proxy server 101 if an SQL client it employed, then server 1204 will be an SQL message interface instead of a www server interface. In the preferred embodiment, the proxy server 101 includes a traditional web server program that accepts http requests from external hosts and return the contents in http messages. This server program 1204 is used to provide an interface to hosts.

The client I/O program 1205 in proxy server 101 is a program that controls the communications between the proxy server and the client host 1201. This I/O program 1205 can be implemented in a typical CGI as a backend portion of the www server 1204. The database search program 1206 is a program that retrieves data from databases as requested by client host 1201. Program 1206 can be a well known database software which divides client requests and forwards them to multiple server hosts 104 as shown by FIG. 12. The requests are forwarded to the various server hosts by a server I/O program 1207.

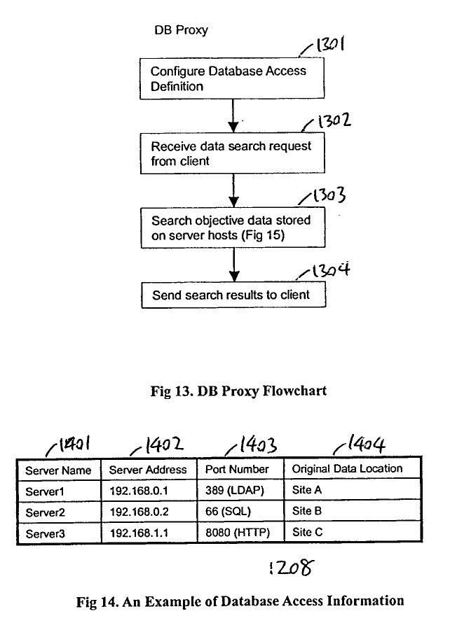

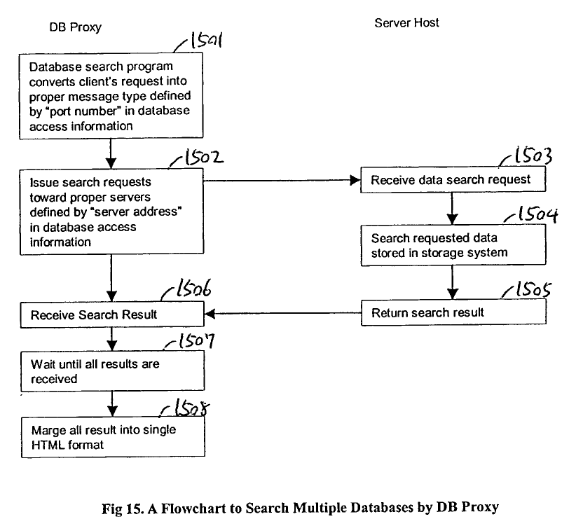

FIG. 13 is a flowchart for the DB proxy architecture 101. Initially, as shown by step 1301, the DB proxy operator configures the database information 1208 (see FIG. 14) to initialize the proxy setting. The DB proxy 101 receives a data search request from the host 1201 in whatever desired message format is being employed, e.g., SQL, http, LDAP, etc. This is illustrated at step 1302. At step 1303 the DB proxy 101 forwards the request to the multiple server hosts 104 as will be described in conjunction with FIG. 15. The DB proxy 101 also receives the results from the multiple servers and sends them to the client hosts, as illustrated by step 1304.

FIG. 14 is a diagram illustrating database access information. This is the information 1208 referred to above in conjunction with FIG. 13. The database access information includes a server name 1401, a server address 1402, a port number 1403, and original data location information 1404. The server name column 1402 shows the server name definition which the DB proxy 101 uses as its target for forwarding data search requests. The server address 1402 is the IP address assigned to each server, while the port number shows the type of data search service employed by the server host, e.g., LDAP, SQL, etc. The original data location refers to the location of the primary site, for example as depicted in FIG. 1.

FIG. 15 is a flowchart illustrating a search of multiple databases using the DB proxy architecture described above. Operations by the DB proxy are shown in the left-hand column, and by the server host in the right-hand column. Initially, the database search program 1206 (see FIG. 12) at the DB proxy 101, converts the client request into a proper message type as defined by the port number 1403 (see FIG. 14) in the database access information. For example, the http request from client 1201 must be converted into an LDAP request format to form an understandable request to the LDAP server, or into an SQL request format to be understandable by the SQL server. This conversion operation is shown at step 1301, and is carried out using well known software. At step 1502, the DB proxy 101 issues the converted request to the proper servers defined in the server address column 1402 and in the database access information 1208. As shown by the right-hand column of FIG. 15, the server host 104 receives this request from the DB proxy 101 in the proper message format 1503. The data management program 1206 at each server host 104 then begins to search the requested data stored in that storage system, using the host I/O program 311. This operation is shown at step 1504.

Next, as shown in step 1505, the server host 104 returns the search result to the DP proxy 101, which receives it at step 1506. At step 1507 the DB proxy 101 awaits replies from all servers 104 to assure the results are complete. As shown at step 1508, once all results are received and complete, the proxy 101 merges the results into a single message using the client I/O program 1205 (see FIG. 12).

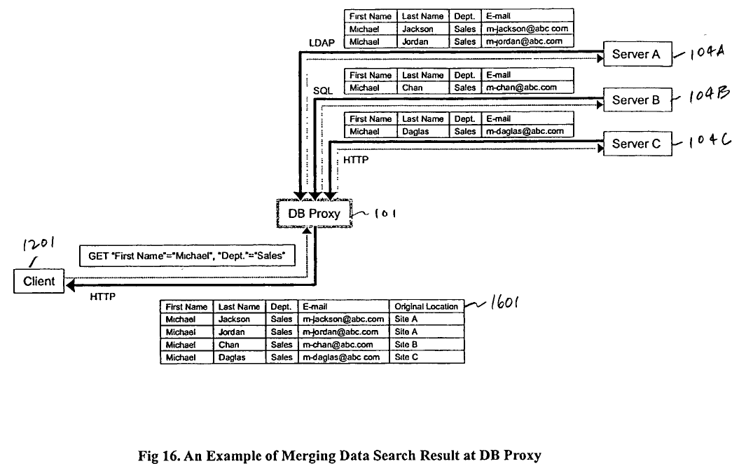

FIG. 16 illustrates the overall operation of this system for one sample query. In the example, a client 1201 has sent a request to the DB proxy 101 requesting all individuals whose first name is Michael and who work in the Sales Department in any office. The DB proxy 101 has divided that request into three appropriately formatted queries to access the three hypothetical sites where this information would be maintained. It addresses server A 104A in LDAP format, server B 104B in SQL format, and server C 104C in http format. Each of those servers queries its associated database using the data management program appropriate for that query and returns information to the DB proxy 101 in response to the query. As shown, server A has returned the names of two employees, and each of servers B and C returned the name of a single employee. The DB proxy 101 then merges the collected information, as shown by table 1601, and presents it back to the client 1201. In table 1601, the first name, last name, department and email address for each employee is provided. In addition, the location of the original site from which that information was derived is also presented.

The preceding has been a description of a preferred embodiment of the invention. It will be appreciated that there are numerous applications for the technology described. For example, large corporations having many branches remotely situated from each other, in which each has its own storage system and manages data individually, can be coordinated. Thus, a main office can collect distributed data into a large single storage system. This enables employees at one office to have complete access to all data in the system.

In another example, a central meteorological office can collect and manage weather information from thousands of observatories situated all over the world, appropriately querying and retrieving information relating to weather conditions at each site. As another example, the system provides data redundancy enabling protection of data despite system crashes, natural disasters, etc., at various sites. These applications are made possible in heterogeneous environments, using legacy systems, but are transparent to the operator.

The scope of the invention will be defined by the appended claims.

What is claimed is:

1. A system for facilitating retrieval of information in which a first system stores first data at a first location and a second system stores second data at a second location, the first system and the second system being coupled together by a network, the system comprising:
a terminal connected to retrieve data from the first system;
at least one replication software program for copying data from the second system to the first system; and
a proxy system operating at the first location to enable a user of the terminal to retrieve data from the second system which data have been copied to the first system from the second system.

2. A system as in claim 1 wherein the replication software program comprises a mirroring program.

3. A system as in claim 2 wherein the data comprises data from a database.

4. A system for facilitating retrieval of information comprising:.
a first system storing first data at a first location;
a second system storing second data at a second location;
a third system located at a third location remote to the first and second locations, but connected to the first and second locations by a network, from which third system an operator is to retrieve information;
at least one replication software program for copying data from the first system over the network to the third system and for copying data from the second system over the network to the third system; and
a proxy system operating at the third location to enable a user of the third system to retrieve data from the third system which has been copied to the third location from the first system and from the second system.

5. A system as in claim 4 wherein each of the first data and second data comprises data stored in a database.

6. A system for facilitating retrieval of information stored in databases at different locations comprising:
a first system storing first database information at a first location and being coupled to a network, the first system having mirroring software to enable copying of the database information from the first system to a remote system at a remote location over the network;
a second system storing second database information at a second location and being coupled to the network, the second system also having mirroring software to enable copying of the database information from the second system to the remote system over the network;
a proxy system operating on the remote system to enable a user of the remote system to retrieve data copied from the first system and copied from the second system to the remote system.

7. A system for facilitating retrieval of information stored at a plurality of different remote locations which information is copied from the remote locations to storage at a local site comprising:
a terminal coupled to access the storage at the local site; and
a proxy server at the local site which accesses information copied to the local site from the remote locations.

8. A method of facilitating retrieval of information stored at a plurality of different locations comprising:
at each of the plurality of locations, performing a data back-up operation to cause data at that location to be copied over a network to a first location;
providing a user coupled to the first location with a proxy server to access the data backed up to that location; and
using the proxy server at the first location, accessing the data stored at the first location.
